(19) United States
(12) Patent Application Publication
(10) Pub. No.: US 2016/0174762 A1
(43) Pub. Date: Jun. 23, 2016

(54) WARMABLE PAD

(71) Applicant: Julius S. CSABAI, Baie d'Urfé (CA)

(72) Inventor: Julius S. CSABAI, Baie d'Urfé (CA)

(21) Appl. No.: 14/906,742

(22) PCT Filed: Jul. 16, 2013
(86) PCT No.: PCT/CA2013/050551

§ 371 Date: Jan. 21, 2016

(51) Int. Cl. A47J 36/24

(52) U.S. Cl. CPC A47J 36/2494

(57) ABSTRACT

A warmable pad and method for mounting the same to a ware, such as a dinner plate, are described. The pad has a first border and a first contact surface which can be removably applied to a surface of the ware. The pad also has a depression recessed from the first border and which contains air. The pad also has a second contact surface which is compressed by the user when the first border is placed against the surface of the ware. The compression of the second contact surface forces air out of the depression and pushes the first contact surface toward the surface of the ware. This lowers the pressure between the first contact surface and surface of the ware, creating a suction effect maintaining the pad against the ware. The pad can be warmed before being removably mounted to the ware so as to warm the ware, and any food or beverage it may contain.

### FIELD OF THE INVENTION

The present invention relates to pads for kitchenware. More particularly, the present invention relates to a pad for being removably mounted to a ware so as to heat the food and beverage contained by the ware, for example, as well as to a corresponding method for removably mounting a pad to a ware.

### BACKGROUND OF THE INVENTION

Ever since the first dinner plate was made, there has been a continual desire to keep the food being served heated to a certain temperature during the time of serving and consumption. This desire is particularly apparent in restaurants, banquet halls, hospitals, nursing residences, and the like, where the time separating the preparation of the food, its service, and its consumption can be long. This desire is also observed in private residences, as it would be a welcome benefit to be able to keep the family's meal warm for an extended period of time.

In order to address this desire in restaurants and at homes, dinner plates can be pre-heated to a desired temperature either in conventional ovens, dishwashers, or with heating pads. In one example of such pre-heating, some ceramic dinner plates can be heated rapidly in microwave ovens. With this method of heating, the entire body of the plate warms up uniformly, but it can be too hot to handle and the retention of heat may not be sufficiently long. This can be attributed to the low heat storage capacity of conventional dinner plates, due to their thin wall construction.

There is therefore presently a need in the food-serving industry to keep served food and beverages warm for an extended period of time.

The Applicant is aware of US patent application having publication number US 2006/0011619 A1, which relates to a warmer for heating a dining plate from beneath, the plate having a ridge on its lower surface for resting on a supporting surface. The warmer comprises a heat absorbing material, and when the plate is set on the warmer, the heat absorbing material contacts a substantial portion of the lower surface of the plate interior to the supporting ridge.

The Applicant is also aware of the following U.S. Pat. Nos. 2,690,743; 4,143,647; 4,210,124; 4,246,884; 4,743,726; 4,931,608; 5,052,369; 5,107,087; 5,260,536; 5,508,498; 5,520,103; 5,601,744; 5,611,328; 5,630,959; 5,871,527; 5,916,470; 6,147,337; 6,828,533 B2; 7,176,426 B2; 7,365,292 B2; 2006/0048768 A1 2007/0141929 A1 2007/0295716 A1 2009/0145420 A1 and 2012/0103562 A1.

The Applicant is also aware of the following patent document: GB 2296319.

Some of the disadvantages associated with some of the conventional devices used to warm plates may include: a) they may not be heatable in microwave ovens; b) they may take too long to heat up; c) only one device at a time can be heated; d) they may not have sufficient heat storage capacity; e) they may not be easily adapted to conventional plates; f) they may be difficult to handle; g) they may not be sufficiently durable; h) they may need to be permanently affixed to the plate, or are difficultly removed therefrom; i) they may be made from relatively expensive materials; and j) they may not be used in a dishwasher.

Hence, in light of the aforementioned, there is a need for a device which, by virtue of its design and components, would be able to overcome or at least minimize some of the aforementioned prior art drawbacks.

### SUMMARY OF THE INVENTION

One object of the present invention is to provide a solution to at least one of the above-mentioned prior art drawbacks.

In accordance with an aspect of the present invention, there is provided a pad for being removably mounted to a ware having a surface for containing food or beverage, the pad comprising:

a first border delimiting a first contact surface for being removably applied against the surface of the ware;

a depression recessed from the first border, the depression shaped to delimit a volume of air; and

a second contact surface disposed opposite the first contact surface, the second contact surface being positioned, shaped, and sized for receiving an input force upon the first border being placed against the surface of the ware, the input force compressing the second contact surface towards the surface of the ware so as to force air out of the depression and apply at least part of the first contact surface against the surface of the ware, the forcing of air out of the depression creating a partial vacuum effect maintaining the at least part of the first contact surface against the surface of the ware, thereby removably mounting the pad to the ware, wherein the pad is formed as one piece.

In some optional embodiments, the first and second contact surfaces can be oval, elliptical, circular, or polygonal. Furthermore, the depression may be recessed from the first border so as to form a substantially concave cavity.

In some optional embodiments, the pad is made from a resilient material, which can include an elastomer comprising a flexible matrix mixed with a heat-absorbing additive.

In accordance with another aspect of the present invention, there is provided a method for removably mounting a warmable pad to a ware having a surface for containing food or beverage, the pad having a first border delimiting a first contact surface, an opposed second contact surface, and a recessed depression shaped to delimit a volume of air, the pad being formed as one piece, the method comprising the steps of:

a) placing the first border against the surface of the ware; and

b) applying an input force to the second contact surface so as to force air out of the depression and apply at least a part of the first contact surface against the surface of the ware, the forcing of air out of the depression creating a partial vacuum effect maintaining the at least part of the first contact surface against the surface of the ware, thereby removably mounting the pad to the ware.

In some optional embodiments, the method includes the step of removing the pad from the ware by applying a dislodging force to at least one of the first border and the second contact surface.

In some optional embodiments, the method includes the step of warming the pad. The warming of the pad can be performed for a maximum of about 3 minutes in a 1,200 Watt microwave oven. When being warmed in the microwave oven, the second contact surface can be placed within the microwave oven so that it faces upward. The warming of the pad can also be performed for a minimum of about 20 minutes in a conventional oven.

In accordance with yet another aspect of the present invention, there is provided a warmable pad for being removably mounted to a ware having a surface for containing food or beverage so as to warm the ware and the food or beverage, the pad comprising:

a first border delimiting a first contact surface for being removably applied against the surface of the ware;

a depression recessed from the first border, the depression shaped to delimit a volume of air; and

a second contact surface disposed opposite the first contact surface, the second contact surface operable between an unattached configuration and a warming configuration, wherein the pad is formed as one piece and wherein:
in the unattached configuration, the second contact surface and the first contact surface are removed from the surface of the ware, and
in the warming configuration, the first contact surface has a warming temperature, the first border is placed against the surface of the ware, and the second contact surface receives an input force compressing the second contact surface towards the surface of the ware so as to force air out of the depression and apply at least a part of the first contact surface against the surface of the ware, the forcing of air out of the depression creating a partial vacuum effect maintaining the at least a part of the warmed first contact surface against the surface of the ware, thereby removably mounting the pad to the ware so as to warm the ware and the food or beverage.

The components, advantages and other features of the invention will become more apparent upon reading of the following non-restrictive description of some optional configurations, given for the purpose of exemplification only, with reference to the accompanying drawings.

### BRIEF DESCRIPTION OF THE DRAWINGS

FIG. 1 is a perspective view of a warmable pad for being removably mounted to a ware, according to an optional embodiment of the present invention.

FIG. 2A is a perspective view of a warmable pad, according to another optional embodiment of the present invention.

FIG. 2B is a sided elevational view of the warmable pad of FIG. 2A.

FIG. 3 is a cross-sectional view taken along the line III-III of FIG. 1, showing a first border of a warmable pad being removably mounted against a surface of a ware, according to another optional embodiment of the present invention.

FIG. 4 is a cross-sectional view of the warmable pad and the ware of FIG. 3, a first contact surface of the warmable pad being shown applied to the surface of the ware.

FIG. 5 is a cross-sectional view of a warmable pad being removably mounted to a surface of a mug, according to another optional embodiment of the present invention.

### DETAILED DESCRIPTION OF PREFERRED EMBODIMENTS OF THE INVENTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present invention illustrated in other figures can be easily inferred therefrom. The embodiments, geometrical configurations, materials mentioned and/or dimensions shown in the figures are optional, and are given for exemplification purposes only.

Furthermore, although the present invention may be used to warm a ware, such as a dinner plate, for example, and as a result, is sometimes described in the context of being used to warm a plate being served, it is understood that it may be used for other purposes, and with other kitchenware. Some of this kitchenware includes, but is not limited to, dishware, cups, mugs, bowls, glasses, etc. Similarly, some other purposes for which the present invention can be used include, but are not limited to, non-slip contact, comfort layer, aesthetically pleasing decoration, etc. For this reason, expressions such as “dinner”, “food”, “restaurant”, “serving”, “warming”, etc. as used herein should not be taken as to limit the scope of the present invention to dinner plates and/or warming of the ware in particular. These expressions encompass all other kinds of materials, objects and/or purposes with which the present invention could be used and may be useful, as can be easily understood.

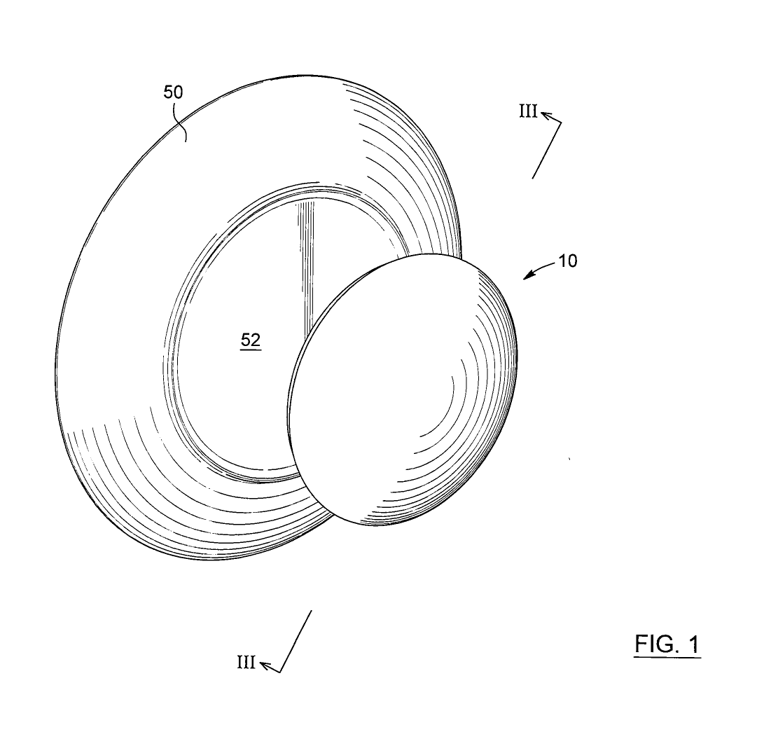

Broadly described, the warmable pad 10, an example of which is shown in FIG. 1, is an article which, in some of its configurations, absorbs sufficient thermal energy, which can then be transferred to the attached ware (e.g. a dinner plate) so as to warm the ware for a period of time. This heat-storing pad 10 can be attached to any flat surface (e.g. such as the bottom of a dinner plate) by squeezing out air as the pad 10 is flattened against the bottom of the plate. This suction-generated vacuum force helps to keep the pad 10 attached to the bottom of the dinner plate for any desired length of time for a temporary adhesion. A simple and effortless hand-movement is sufficient to break the vacuum force for a quick release.

Still referring to FIG. 1, and according to an aspect of the present invention, there is provided a warmable pad 10 for being removably mounted to a ware 50 which can contain food and beverage, and which has a surface 52. The term “warmable” refers to the ability of the pad 10, in most of its embodiments, to absorb thermal energy by any suitable technique, such as by using a microwave or conventional oven, and to store this absorbed thermal energy for a certain duration of time. Such a warmable pad 10 can be used to transfer its absorbed thermal energy to the surface 52 of the ware 50, and ultimately, to the food or beverage being contained in the ware 50. The warmable pad 10 is not limited to being used solely for transferring heat to the ware 50, and can also be used for other purposes (e.g. non-slip contact, comfort layer, aesthetically pleasing decoration, etc.) as previously explained.

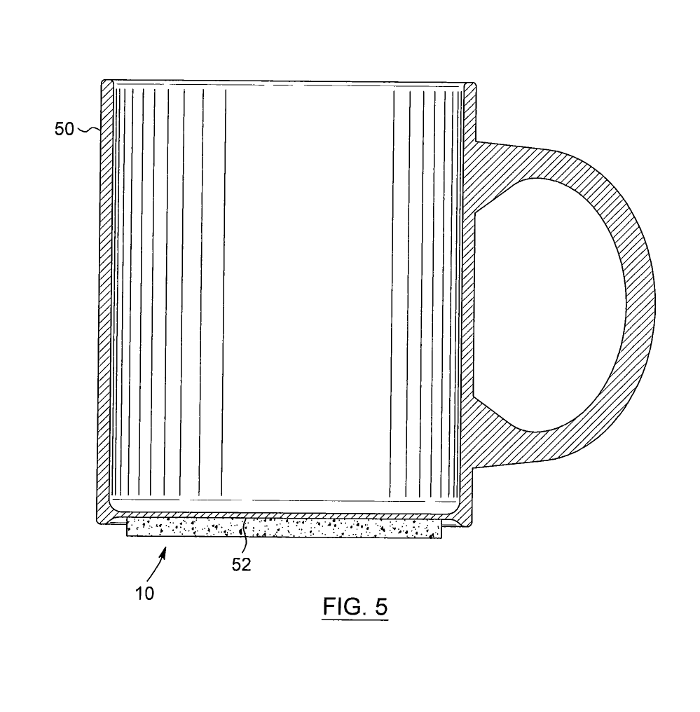

As also previously explained, the ware 50 can be any receptacle or container which can be used for containing and/or serving food or beverages. The surface 52 of the ware 50 can be any face or area covering a portion of the ware 50 against which the pad 10 can be mounted. In the example where the ware is a mug, as shown in FIG. 5, the surface 52 can be the bottom face of the mug. The surface 52 can also be located on the sides, top, or other portions of the ware 50.

In the example where the ware 50 is a dinner plate, as shown in FIG. 1, the surface 52 can be the bottom face of the dinner plate. Such a dinner plate can also include a region having an area delimited by a supporting ridge on the bottom of the dinner plate. This bottom region can provide a substantially flat and smooth surface 52 or mostly circular or oval shape against which the pad 10 can be removably mounted, and can also define the area of the dinner plate to be heated. The height of the bottom region may vary with each make of dinner plate, but typically falls into a range of ⅛″ to ¼″, and the diameter typically varies from 5¾″ to 6½″. Such a dinner plate may be constructed mostly from porcelain or china, but also from other kinds of materials, such as: glass, metal, plastics and earthenware.

The expression “removably mounted” refers to the ability of the pad 10 to be attached to the surface 52 of the ware 50 for the required amount of time (i.e. so as to transfer its absorbed heat), and easily removed therefrom. In some optional embodiments, the removal of the pad 10 from the surface 52 of the ware 50 can be easily accomplished by applying a dislodging force to some part of the pad 10.

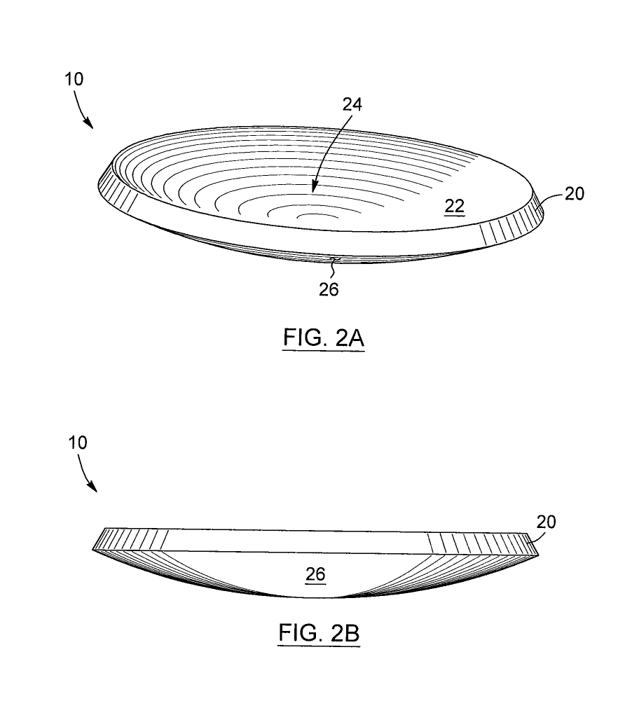

The pad 10 has a first border 20, an example of which is shown in FIGS. 2A and 2B. The first border 20 is configured for being placed against the surface of the ware so as to removably mount the pad 10 to the ware. The first border 20 can consist of any band, edge, margin, or other like boundary which contours the bounds of the pad 10. The first border 20 can be of any suitable thickness, such thickness optionally corresponding to the thickness of the pad 20, as shown in FIGS. 2A and 2B. In some embodiments, the thickness of the pad 20 can vary between about 0.125 inches and 1.00 inches, and other thickness values are also possible. The first border 20 is not limited to spanning the outer edge of the pad 10, and can also span the boundaries of the one or more depressions discussed below. In so doing, the first border 20 delimits or marks a first contact surface 22 which is configured for being removably applied against the surface of the ware. In the embodiment where the pad 10 warms the ware and any food or beverage contained therein, the first contact surface 22 forms the medium through which thermal energy is transferred mainly by conduction from the pad 10 (i.e. the first contact surface 22) to the surface of the ware, and ultimately, to the food or beverage.

The pad 10 also includes a depression 24, an example of which is also shown in FIGS. 2A and 2B. The depression 24 can be any cavity, crater, hollow, pocket, or other similar void which contains a volume of air, and which can be elastically deformed such that the air, or some portion thereof, can be forced from the depression 24, as further explained below. The depression 24 is recessed from the first border 20. The term “recessed” can refer to the position of the depression 24 with respect to the first border 20, in that the depression 24 is set back from the plane defined by the contour of the first border 20. For example, in the embodiment shown in FIG. 2A, the depression 24 appears as a substantially concave cavity which is lower than a plane defined by the upper rim of the first border 20. In this example, the pad 10 forms a shallow, dome-like object. In some embodiments, the depression 24 and the first contact surface 22 are coextensive, in that the first contact surface 22 forms the face of the depression 24. Further optionally, the pad 10 can include more than one depression 24. In such an embodiment, depression 24 “pockets” can be located throughout the pad 10, each depression 24 containing a volume of air and being elastically deformable.

Still referring to FIGS. 2A and 2B, the pad 10 also has a second contact surface 26. The second contact surface 26 permits the user of the pad 10 to removably mount it to the surface of the ware, as will be further explained below. It also provides a surface which can be set against a table or other support so as to support the weight of the pad 10 and/or ware, and provide a frictional contact so as to prevent slippage, further advantageously providing stability. The second contact surface 26 is disposed opposite the first contact surface 22. The expression “disposed opposite” refers to the orientation of the second contact surface 26 with respect to the first contact surface 22. For example, in the embodiments shown in FIGS. 2A and 2B, the second contact surface 26 faces downward and the first contact surface 22 faces in an opposite direction, i.e. upward. Furthermore, the shape of the first or second contact surfaces 22,26 can vary. In some embodiments, the shapes can be substantially oval, circular, elliptical, and/or polygonal. Other shapes for the first and second contact surfaces 22,26 are possible, and can depend upon the following non-exhaustive list of factors: the shape of the ware, the desired aesthetics for the pad 10, the nature and cost of the materials being used, etc. In the embodiment where the first and second contact surfaces 22,26 are substantially circular, thus defining a circular pad 10, the diameter of such a pad 10 can be less than or equal to about 9 inches, as measured when the first contact surface 22 is applied substantially flat against the surface of the ware. The value of 9 inches can also refer to the length of the diagonal of a pad 10 that is substantially rectangular, for example.

As previously mentioned, the second contact surface 26 allows the user of the pad 10 to removably mount it to the surface of the ware. This removable mounting will now be described in more detail.

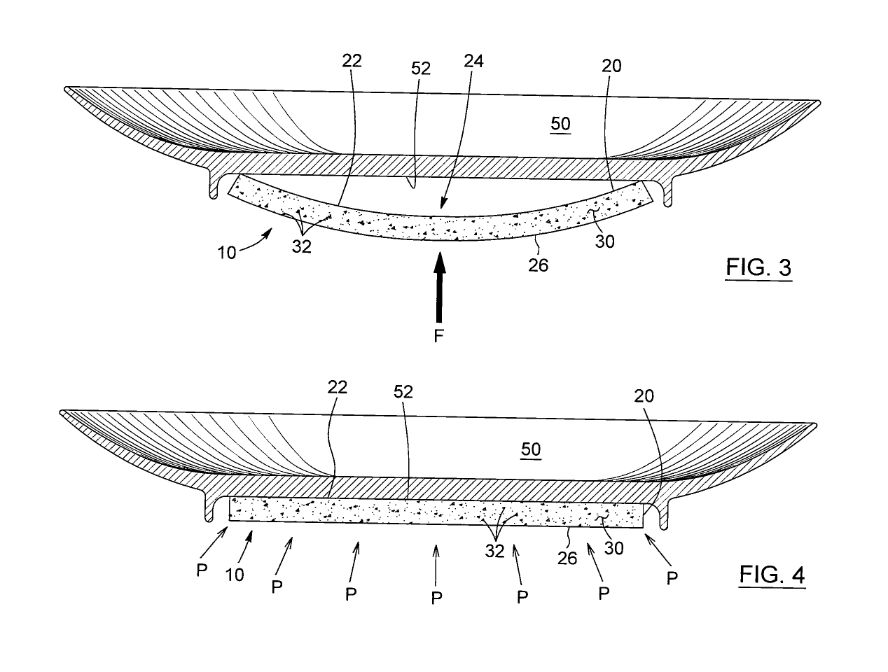

Referring to FIGS. 3 and 4, the second contact surface 26 is positioned, shaped, and sized for receiving an input force F from the user of the pad 10. The expression “positioned, shaped, and sized” refers to the configuration of the second contact surface 26, which is arranged with respect to the surface 52 of the ware 50 such that it responds to this input force F so as to allow the pad 10 to be removably mounted to the surface 52. More particularly, the input force F is typically applied at the same time as, or just after, the first border 20 is placed against the surface 52 of the ware 50, as exemplified in FIG. 3. The placement of the first border 20 in this fashion may advantageously form a seal preventing, or significantly reducing, the ingress of air into the volume delimited by the first border 20. Such a seal will help to produce and maintain the suction effect described in more detail below.

The application of the input force F against the elastically deformable second contact surface 26 compresses the second contact surface 26 towards the surface 52 of the ware 50, as exemplified in FIG. 4. This compression of the second contact surface 26 forces the air out of the depression 24, and also applies or pushes some, or all, of the first contact surface 22 towards the surface 52 of the ware 50. This compression caused by the input force F further brings this portion of the first contact surface 22 into substantially direct contact with the surface 52. In so doing, there remains very little air in the space between the compressed first contact surface 22 and the surface 52 of the ware 50.

Since the aforementioned seal created by the placement of the first border 20 prevents or significantly reduces the ingress of air into this space, this space will likely have a lower pressure than the surrounding atmosphere. Thus, a “suction effect” is created, whereby the surrounding atmosphere exerts a pressure force P against the second contact surface 26 and/or pad 10, and pushes or forces the pad 10 towards the surface 52 of the ware 50, an example of which is shown in FIG. 4. The pressure force P created by this suction effect also maintains the portion of the first contact surface 22 against the surface 52 of the ware 50. The length of time for which the suction effect can be maintained depends mainly on how long it takes the air to leak back into the space between the first contact surface 22 and the surface 52 of the ware 50, thus equalizing the pressure with the surrounding atmosphere. The time for such leaking to occur can vary, and can depend on the following non-exhaustive list of factors: the smoothness and cleanliness of both the first contact surface 22 and the surface 52 of the ware 50, the strength of the seal described above, the pressure of the surrounding atmosphere, etc.

In light of the preceding, it can thus be appreciated how the pad 10 is removably mounted to the ware 50. It can also be appreciated that the maintaining of the first contact surface 22 against the ware 50 can provide a substantially conductive contact through which heat can be transferred from the pad 10 to the ware 50, and ultimately, to the food or beverage contained therein.

Having described some of the features and components of the pad 10, its material composition will now be further explained.

Still referring to FIGS. 3 and 4, and in some embodiments, the pad 10 can be made from a resilient material, such as a non-conductive elastic material. The elastic material may advantageously allow the pad 10 to undergo peripheral deformation (or radial stretching) which is desired when the pad 10 is flattened against surface 52 of the ware 50. The resilient material can be any suitable material which allows the pad 10 to regain its original shape and form after having been compressed or otherwise deformed. Such a material can allow the second contact surface 26, for example, to be elastically compressed so as to force air out of the depression 24 and compress the first contact surface 22 towards the surface 52 of the ware 50. More particularly, the resilient material may consist of an elastomer having a flexible matrix 30 into which is mixed a heat-absorbing additive 32. In such an embodiment, the pad 10 can consist of a resilient homogeneous body of solid elastomer which is saturated with a significant percentage of heat-absorbing and heat-storing material.

The flexible matrix 30 may provide the resiliency and elasticity required of the pad 10 while also providing structure. The flexible matrix 30 can also be resistant to the heat transferred to the pad 10, thereby advantageously allowing the pad 10 to be handled by the user. In some embodiments, the flexible matrix 30 can be a material selected from the group of elastic materials which consists of nitrile, neoprene, ethylene propylene, fluorocarbon, polyurethane, and silicon rubber. Of course, other heat-resistant materials can be used. In the embodiment where the flexible matrix 30 is silicon rubber, the silicon rubber may have a percent composition of at least about 5%, on a weight basis of the pad 10, and a maximum of about 95%, on a weight basis of the pad 10. In general, silicon rubber is non-reactive, stable and resistant to extreme environments and temperature, while still maintaining its properties. Silicon rubber can be a highly inert material which does not react with most chemicals. Due to its inertness and hygienic properties, it is suitable for many applications in the food industry. Optionally, the silicon rubber can have a hardness expressed in Shore A or IRHD of between about 10 to about 100.

The heat-absorbing additive 32 can be mixed with the flexible matrix 30 so as to form the pad 10. The heat-absorbing additive 32 absorbs the thermal energy transferred to the pad 10 by a warming device (e.g. a microwave or a conventional oven, for example), stores this thermal energy for a given period of time, and/or transfers the thermal energy to the ware 50 via the first contact surface 22. In some embodiments, the heat-absorbing additive 32 can be any suitable heat-absorbing and storing material selected from a group having a high specific gravity. Some examples of such a material include particles of ferrite, such as steel or iron particles. Other examples include minerals rich in iron oxides, such as magnetite, hematite, goethite, limonite, and siderite, to name but a few. The size of the particles of the heat-absorbing additive 32 can vary. In some optional configurations, the size of the particles is less than about 300 microns. The mixing of the heat-absorbing additive 32 within the flexible matrix 30 advantageously allows for the pad 10 to absorb a suitable amount of thermal energy while minimizing the risk that any particular portion of the pad 10 will absorb too much thermal energy, and thus be too hot to handle. The percent composition of the heat-absorbing additive 32 in the pad 10 can vary depending on the following non-exhaustive list of factors: the desired stiffness of the pad 10, the manufacturing costs, and the desired elasticity of the pad 10.

According to another aspect of the present invention, there is provided a method for removably mounting a warmable pad 10, such as the one described above, to a surface 52 of a ware 50 for containing food or beverage. As with the embodiments of the pad 10 described above, the pad 10 of the method includes a first border 20 delimiting a first contact surface 22, an opposed second contact surface 26, and a recessed depression 24 having a volume of air.

The method includes the step of placing the first border 20 against the surface 52 of the ware 50, as exemplified in FIG. 3. As previously explained, the placement of the first border 20 against the surface 52 may form a seal for facilitating the application of the first contact surface 22 via the suction effect. In some embodiments, the first contact surface 22 may be cleaned prior to being applied against the surface 52 of the ware 50. Such cleaning may advantageously improve the effectiveness and duration of the suction effect described above.

The method also includes the step of applying an input force F to the second contact surface 26, as exemplified in FIG. 4. As previously explained, the application of such the input force F forces air out of the depression 24 and applies at least a part of the first contact surface 22 against the surface 52 of the ware 50. This forcing of air out of the depression 24 helps to create the suction effect maintaining the part of the first contact surface 22 against the surface 52 of the ware 50, and thus removably mounts the pad 10 to the ware 50.

The expression “at least a part of the first contact surface” refers to the tendency of the first contact surface 22, in some optional embodiments, to form a peripheral, or “ring-shaped” contact area with the surface 52 of the ware 50. In some embodiments, the size of this contact area can be about 30% of the total area of the first contact surface 22 attached to the surface 52. In these optional embodiments, this reduced contact area may be the only medium through which heat is transferred to the ware 50 by direct thermal conduction. For the remaining portion of the first contact surface 22 which is not in direct contact with the surface 52, thermal energy can be transferred to the ware 50 through radiation. In some optional embodiments, the pad 10 can be removed from the ware 50 by applying a dislodging force against the first border 20, the second contact surface 26, and/or any other suitable part of the pad 10.

In the embodiment where the pad 10 transfers heat to the ware 50, and ultimately, to the food contained in the ware 50, the method can include the step of warming the pad 10. The pad 10 may be warmed in any suitable warming device. Some typical warming devices which may be used include microwave ovens or conventional ovens used in commercial or private establishments. The expression “conventional oven” refers to typical gas or electric fired ovens found in private residences or restaurants. In the embodiment where a 1,200 Watt microwave oven is used, the warming of the pad 10 may include warming the pad 10 for a maximum of about 3 minutes, and in some further optional embodiments, about 1 minute. Further optionally, it may be desirable to place the pad 10 upside-down in the microwave oven, with the second contact surface 26 facing upward, so as to better distribute thermal energy over the entire surface of the pad 10. In the embodiment where a conventional oven is used, the warming of the pad 10 may include warming the pad 10 for at least about 20 minutes at a temperature setting between about 200° F. and about 225° F. Whether warmed in a microwave oven, a conventional oven, or any other warming device, the pad 10 may be warmed separately from the ware 50 so as to be attached to the ware 50 later on.

The warming of the pad 10 aims to impart a certain amount of thermal energy to the ware 50 over a period of time. In so doing, the top surface of the ware 50 which contacts the food or beverage is able to maintain the temperature of the food or beverage at a given value. In some embodiments, the warming of the pad 10 includes warming the pad 10 or at least the first contact surface 22 to a warming temperature of at least about 150° F. By warming the pad 10 or first contact surface 22 to such a warming temperature, the top surface of the ware 50 can be maintained at a certain temperature, such as about 125° F. for example, which may be ideal for many food-serving settings. In some embodiments, this warming temperature, or any warming temperature above about 100° F., is maintained for at least 10 minutes, due at least in part to the material composition of the pad 10 described above. After these at least 10 minutes, the pad 10 may cool down to a lower, lukewarm temperature. Depending on the warming temperature of the pad 10 and the user's sensitivities, the user may wish to use a glove or other hand covering to handle or manipulate the warmed pad 10.

The above warming temperatures and durations are given for the sole purposes of describing the warming of the pad 10. It will be appreciated that the warming temperatures and durations may vary depending on the following non-exhaustive list of factors: the initial temperature of the food or beverage being served, the quantity of food or beverage being served, the consistency of the food or beverage being served (e.g. bulky like chili, or chunky like fish & chips), and the intended speed of consumption.

According to another aspect of the present invention, an example of which is shown in FIGS. 3 and 4, there is a provided a warmable pad 10 for being removably mounted to a ware 50 having a surface 52 for containing food or beverage so as to warm the ware 50 and the food or beverage. The pad 10 can be similar to the one described above, in that it includes a first border 20 delimiting a first contact surface 22, a depression 24 recessed from the first border 20, and a second contact surface 26 opposite the first contact surface 22.

The second contact surface 26 operates between two configurations: an unattached configuration, and a warming configuration. In the unattached configuration, the first and second contact surfaces 22,26, and thus the pad 10, are removed from, and thus not in contact with, the surface 52 of the ware 50. This configuration can correspond to the warming of the pad 10 prior to being removably mounted to the ware 50. In the unattached configuration, the pad 10 is not elastically deformed and takes its usual form.

In the warming configuration, the pad 10 is removably mounted to the surface 52 of the ware 50, thereby allowing for thermal energy to be transferred from the pad 10 to the ware 50 and ultimately, to the food or beverage contained in the ware 50. The removable mounting of the pad 10 to the ware 50 is achieved in the manner already described above.

In light of the preceding, it can be appreciated that the present invention can provide advantages in that, by virtue of its design and components, it provides an affordable, efficient, and safe way to maintain the food or beverage served in a plate or mug, for example, at an elevated temperature so that such food or beverage can be fully enjoyed long after it has been prepared. More particularly, the pad 10 can be mounted to, and removed from, any conventional dinner plate or mug and can heat the contents of these wares so that they are maintained at a consumable temperature, while still preventing the ware from being too hot to handle. In so doing, the present invention provides a solution for the food-serving industry that adopts a simple configuration, which is rapidly microwaveable, and which is relatively inexpensive.

Furthermore, the pad 10 can be made from a resilient material which advantageously acts as an electrical insulator into which the particles of heat-absorbing additive 32 can be dispersed evenly. Therefore, any potential fire hazard resulting from sparking in microwave ovens is greatly reduced. Furthermore, the head-absorbing additive 32 may advantageously meet the two requirements sought after by those in the food-serving industry: rapid thermal energy absorption, and high thermal capacity retention.

Moreover, the present invention may advantageously meet some or all of the following criteria:
it contains a material (i.e. the heat-absorbing additive 32) which heats up in a microwave oven safely;
it can be warmed to a suitable warming temperature in a relatively short period of time (i.e. less than one minute, in some instances);
for large number of food servings, such as in restaurants, numerous pads can be kept heated in a gas or electric conventional ovens;
it provides sufficient heat storage capacity to be able to keep a dinner plate warm for a suitable period of time before its temperature drops below a level at which the food consumption is less enjoyable;
it may be easily adaptable to any currently available dinner plates (microwave safe or unsafe), including ones made from metal or plastic;
it may also be used on restaurants' and family homes' existing plates (e.g. sets of heirlooms and wedding gifts);
it is simple and safe to use;
it is made to be relatively durable;
it can be removably and temporarily attached to any dinner plate, i.e. only for the duration of serving;
it provides heating for only the desired portion of the dinner plate, leaving the handling portions of the plate, such as its rim, safe for being manipulated by hand during serving and consumption;
it may be made out of relatively inexpensive materials; and
it may be used and cleaned in a dishwasher.

Of course, numerous modifications could be made to the above-described embodiments without departing from the scope of the invention, as defined in the appended claims.

1-33. (canceled)

34. A pad for being removably mounted to a ware having a surface for containing food or beverage, the pad comprising:
a first border delimiting a first contact surface for being removably applied against the surface of the ware so as to remain attached thereto;
a depression recessed from the first border, the depression shaped to delimit a volume of air; and
a second contact surface disposed opposite the first contact surface, the second contact surface being positioned, shaped, and sized for receiving an input force upon the first border being placed against the surface of the ware, the input force compressing the second contact surface towards the surface of the ware so as to force air out of the depression and apply at least part of the first contact surface against the surface of the ware, the forcing of air out of the depression creating a partial vacuum effect maintaining the at least part of the first contact surface against the surface of the ware, thereby removably mounting the pad to the ware, wherein the pad is formed as one piece.

35. A pad according to claim 34, wherein the first and second contact surfaces have shapes selected from group consisting of circular, oval, elliptical, and polygonal.

36. A pad according to claim 34, wherein at least one of the first and second contact surfaces is substantially circular, and has a diameter less than or equal to about 9 inches upon the at least part of the first contact surface being applied to the surface of the ware.

37. A pad according to claim 34, wherein the depression is recessed from the first border so as to form a substantially concave cavity.

38. A pad according to claim 34, made from a resilient material.

39. A pad according to claim 38, wherein the resilient material is an elastomer comprising a flexible matrix mixed with a heat-absorbing additive.

40. A pad according to claim 39, wherein the flexible matrix is a material selected from the group of elastic materials consisting of: nitrile, neoprene, ethylene propylene, fluorocarbon, polyurethane, and silicon rubber.

41. A pad according to claim 40, wherein the flexible matrix is silicon rubber, the resilient material having a composition of silicon rubber of at least about 5%, on a weight basis, and a maximum of about 95%, on a weight basis.

42. A pad according to claim 34, wherein the heat-absorbing additive is a heat-absorbing and storing material selected from the group of iron-containing materials consist of:
iron, steel, particles of ferrite, magnetite, hematite, goethite, limonite, and siderite.

43. A pad according to claim 34, wherein the ware is a plate and the surface is a bottom surface of the plate, the pad being removably mounted to the plate upon the first border being placed against the bottom surface of the plate and the input force compressing the second contact surface towards the bottom surface of the plate so as to force air out of the depression and apply the at least part of the first contact surface against the bottom surface of the plate, the forcing of air out of the depression creating a partial vacuum effect maintaining the at least part of the first contact surface against the bottom surface of the plate.

44. A pad according to claim 34, having a thickness between about 0.125 inches and about 1.00 inch.

45. A warmable pad for being removably mounted to a ware having a surface for containing food or beverage so as to warm the ware and the food or beverage, the pad comprising:
a first border delimiting a first contact surface for being removably applied against the surface of the ware so as to remain attached thereto;
a depression recessed from the first border, the depression shaped to delimit a volume of air; and
a second contact surface disposed opposite the first contact surface, the second contact surface operable between an unattached configuration and a warming configuration, wherein the pad is formed as one piece and wherein:
in the unattached configuration, the second contact surface and the first contact surface are removed from the surface of the ware, and
in the warming configuration, the first contact surface has a warming temperature, the first border is placed against the surface of the ware, and the second contact surface receives an input force compressing the second contact surface towards the surface of the ware so as to force air out of the depression and apply at least a part of the first contact surface against the surface of the ware, the forcing of air out of the depression creating a partial vacuum effect maintaining the at least a part of the warmed first contact surface against the surface of the ware, thereby removably mounting the pad to the ware so as to warm the ware and the food or beverage.

46. A warmable pad according to claim 45, wherein the first and second contact surfaces have shapes selected from group consisting of circular, oval, elliptical, and polygonal.

47. A warmable pad according to claim 45, wherein at least one of the first and second contact surfaces is substantially circular, and has a diameter less than or equal to about 9 inches upon the at least part of the warmed first contact surface being applied to the surface of the ware.

48. A warmable pad according to claim 45, wherein the depression is recessed from the first border so as to form a substantially concave cavity.

49. A warmable pad according to claim 45, made from a resilient material.

50. A warmable pad according to claim 49, wherein the resilient material is an elastomer comprising a flexible matrix mixed with a heat-absorbing additive.

51. A warmable pad according to claim 50, wherein the flexible matrix is a material selected from the group of elastic materials consisting of: nitrile, neoprene, ethylene propylene, fluorocarbon, polyurethane, and silicon rubber.

52. A warmable pad according to claim 51, wherein the flexible matrix is silicon rubber, the resilient material having a composition of silicon rubber of at least about 5%, on a weight basis, and a maximum of about 95%, on a weight basis.

53. A warmable pad according to claim 50, wherein the heat-absorbing additive is a heat-absorbing and storing material selected from the group of iron-containing materials consist of: iron, steel, particles of ferrite, magnetite, hematite, goethite, limonite, and siderite.

54. A warmable pad according to claim 45, wherein the ware is a plate and the surface is a bottom surface of the plate, the pad being removably mounted to the plate upon the first border being placed against the bottom surface of the plate and the input force compressing the second contact surface towards the bottom surface of the plate so as to force air out of the depression and apply the at least part of the first contact surface against the bottom surface of the plate, the forcing of air out of the depression creating a partial vacuum effect maintaining the at least part of the warmed first contact surface against the bottom surface of the plate.

55. A warmable pad according to claim 45, having a thickness between about 0.125 inches and about 1.00 inch.
